(19) United States
(12) Patent Application Publication
(10) Pub. No.: US 2008/0267014 A1
(43) Pub. Date: Oct. 30, 2008

(54) Tracking and monitoring system

(76) Inventor: Dequincy A. Hyatt, Shelby Township, MI (US)

Correspondence Address: CARLSON, GASKEY & OLDS, P.C., 400 WEST MAPLE ROAD, SUITE 350, BIRMINGHAM, MI, 48009, US

(21) Appl. No.: 11/739,898

(22) Filed: Apr. 25, 2007

(51) Int. Cl. G04B 47/00

(52) U.S. Cl. 368/10

(57) ABSTRACT

A tracking device is incorporated into a watch. The tracking device appears as an ordinary watch, but cannot be removed by the individual wearing it. If necessary, the location of the tracking device can be determined by a central server and reported to the authorities or to the individual's family.

### BACKGROUND

The present invention relates generally to tracking devices and more particularly to a tracking device which is not removable by the user.

Systems for tracking and monitoring individuals have been developed for several different applications. First, convicted criminals may be sentenced to stay at home for a period of time. If the individual leaves their home without authorization, the authorities activate the tracking device to locate the individual and arrest him. In another application, an individual who has been released on bail may be required to wear a tracking device to ensure his appearance in court for the hearing and for the trial. In these applications, a large, conspicuous electronic device is locked to the individual's ankle and cannot be removed by the individual. Upon activation by the authorities, the location of the individual can be tracked using GPS, cell towers, etc.

Individual tracking devices are also used for Alzheimer's patients. These patients may become confused or disoriented and simply “wander off.” Because these individuals are not consciously trying to avoid being located, their tracking devices need not be locked to the individual. It is not expected that these individuals would make any attempt to remove the tracking device, or that they would even be aware of the tracking device.

However, there is yet another class of individuals for whom tracking and monitoring would be beneficial, who might at times attempt to remove the tracking device, but do not deserve to be treated as criminals. Some mentally ill patients, even mentally ill patients who can function very well when diligently taking their prescribed medications, may occasionally have relapses if they stop taking their medication. During these times, the person may become confused or delusional and may either wander aimlessly or travel quite deliberately long distances while suffering from their delusions. During this time, family members may be unable to locate the individual and get them the help and medication that they need. During these episodes, these individuals may try to remove the tracking devices. However, the conspicuous ankle bracelets used on criminals are inappropriate for these individuals, especially because they are able to function quite normally when taking medication.

### SUMMARY

The present invention provides a tracking device that cannot be removed by the user, but does not appear unusual to other observers. In the embodiments disclosed herein, the tracking device is configured in the form of a watch, or as part of a watch. The watch band is lockable such that it cannot be removed by the wearer, but there is no outward indication that the watch includes a tracking device or is anything other than an ordinary watch.

Like the known tracking devices, the tracking device includes a GPS receiver or other location determining device. The tracking device further includes some means of communicating its location to a central monitoring system. When activated through the central monitoring system, the tracking device transmits its location, as determined by the GPS receiver, to the central monitoring system.

These and other features of the application can be best understood from the following specification and drawings, the following of which is a brief description.

### BRIEF DESCRIPTION OF THE DRAWINGS

FIG. 1A is a perspective view of a tracking device according a first embodiment of the present invention.

FIG. 1B is an enlarged view of the two ends of the watchband of FIG. 1A.

FIG. 2A is an enlarged view of two ends of an alternate watchband.

FIG. 2B illustrates the watchband of FIG. 2A in a locked position.

FIG. 3 illustrates an alternate tracking device.

FIG. 4 illustrates a third alternate tracking device.

FIG. 5 is a schematic of a tracking and monitoring system including one of the tracking devices of FIGS. 1-4.

### DETAILED DESCRIPTION OF THE PREFERRED EMBODIMENT

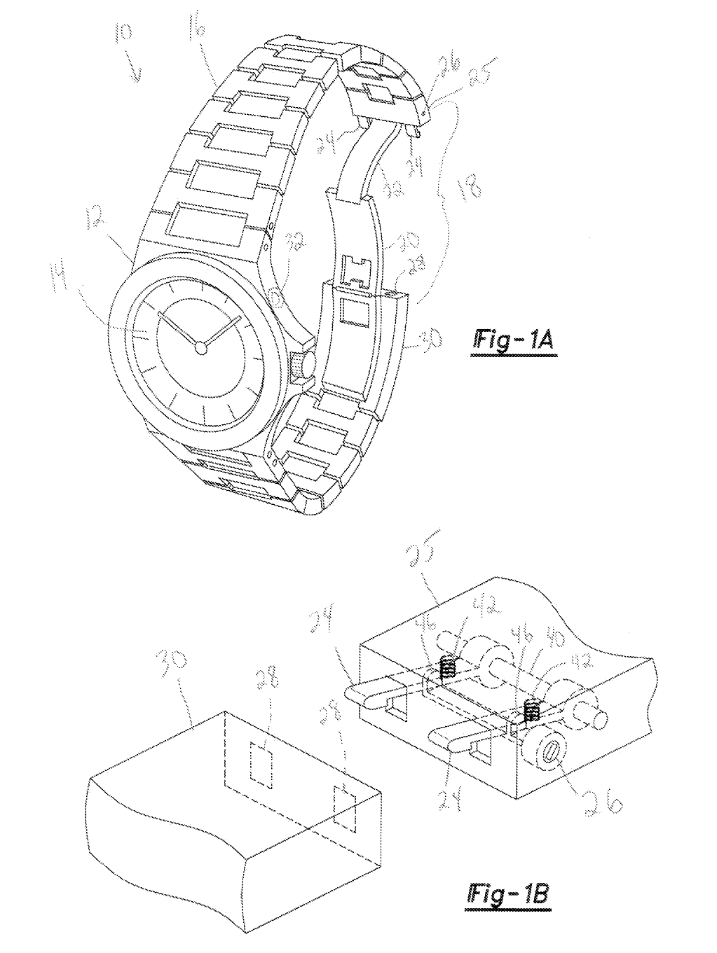

FIG. 1A is a perspective view of a tracking device 10 according to a first embodiment of the present invention. The tracking device 10 includes a watch body 12 having a watch display, such as watch face 14 (watch display could also be a digital display). A watchband 16 is connected to the watch body 12 and is selectively closable by a fastening system 18. The fastening system 18 includes a first curved bar 20 and second curved bar 22 pivotably connected and connecting a first connecting link 25 and a second connecting link 30. A first connecting link 25 includes a pair of hooks 24 extending therefrom. The hooks 24 are selectively lockable by keyway 26. The hooks 24 are also receivable within apertures 28 on the second connecting link 30.

The watch body 12 is fully functional as a watch, including watch hands on a watch face 14. Alternatively, digital watches could also be provided in any of the embodiments shown in this application. The watch body 12 further includes an optional “panic” or “help” button 32 that is recessed into the body 12.

Referring to FIG. 1B, inside the first connecting link 25, the hooks 24 are pivotable on (or pivotable with) a shaft 40 and are biased toward a locked position by springs 42. The hooks 24 are biased downwardly by the springs 42 and can be selectively released by cams 46 rotatable by the keyway 26. The second connector link 30 includes apertures 28 into which the hooks 24 can be received and to which the hooks 24 are latched. When the hooks 24 are inserted into the apertures 28 and the keyway 26 is rotated to the lock position, the springs 42 bias the hooks 24 downwardly, thereby locking the hooks 24 in the apertures 28 and locking the first connector link 25 to the second connector link 30. In this position, the tracking device 10 cannot be removed from the user's wrist. The keyway 26 can be rotated such that the cams 46 push the hooks 24 upwardly, thereby releasing the hooks 24 from the apertures 28 so that they can be removed from the apertures 28 and the first connecting link 25 can be separated from the second connecting link 30 and the tracking device 10 can be removed.

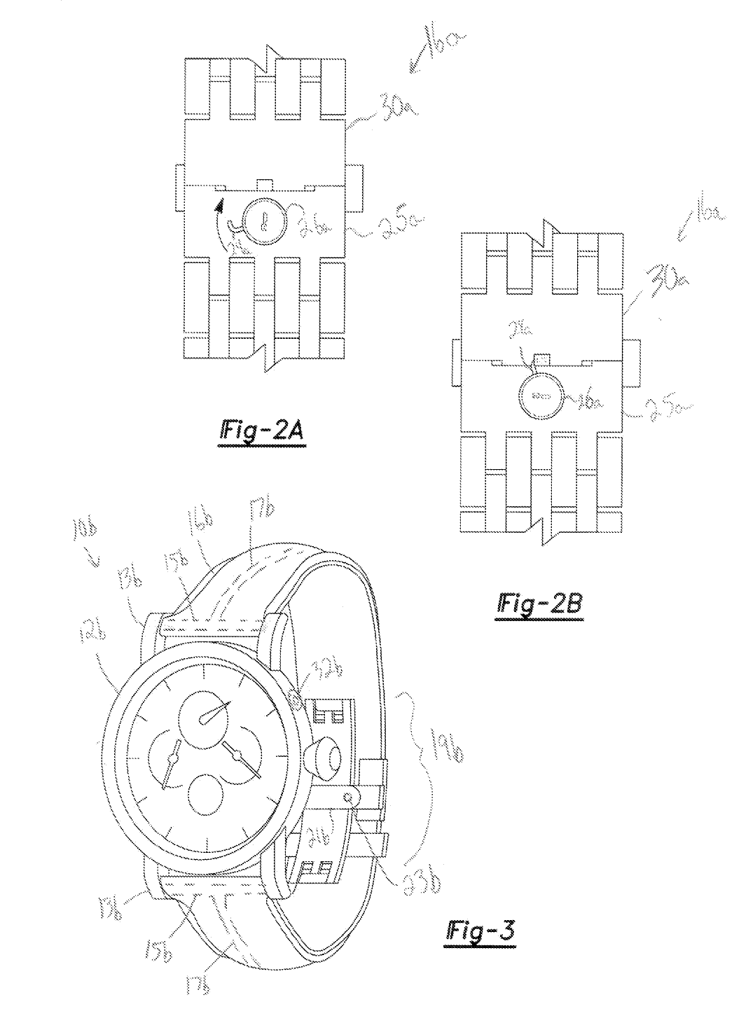

FIGS. 2A and 2B show an alternate connection mechanism. A first connector link 25a is connected to a second connector link 30a by a rotating keyway 26a. A hook 24a rotates inside the first connector link 25a upward rotation of the keyway 26a. The hooks 24a is received within an aperture (not visible) in the second connector link 30a, thereby rendering the watchband 16a irremovable from the user. The watchband 16a can then be removed by unlocking the second connector link 30a from the first connector link 25a by rotation of the keyway 26a.

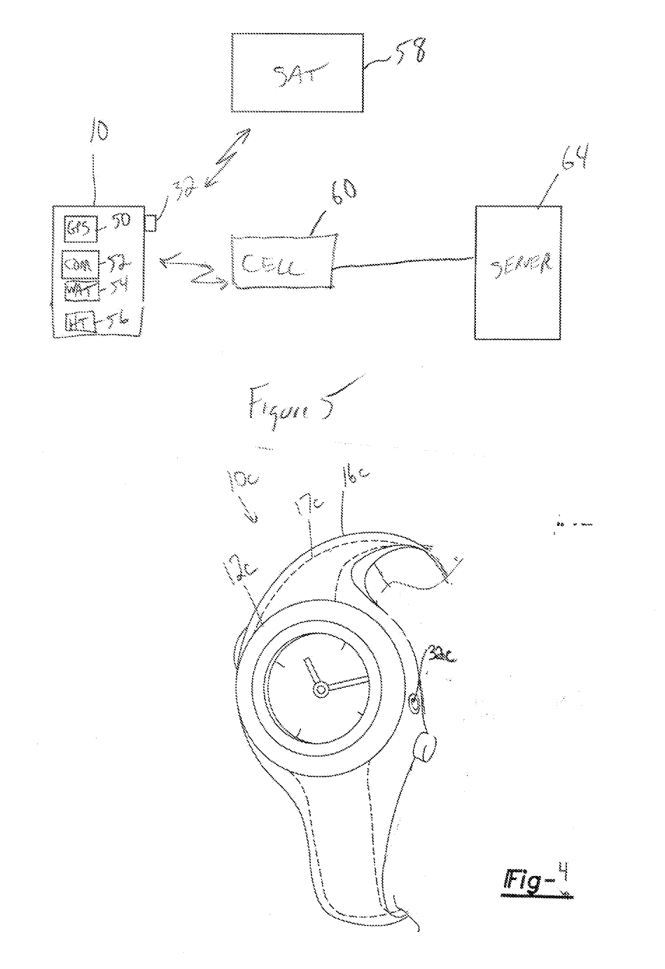

FIG. 3 illustrates a third embodiment of a tracking device 10b. A watch body 12b includes two pair of spaced apart prongs 13b connected by a crossbar 15b. A flexible braided cable 17b is connected to each crossbar 15b. The cable 17b and crossbar 15b are hidden inside another (or other material) watchband 16b. The connection between the two watchband halves may be as indicated in FIG. 1A and FIG. 1B. An adjustment mechanism 19b is also provided. The adjustment mechanism 19b is similar to known watchband mechanisms in which a lever clamps down onto the watchband halves. However, in the tracking device 10b, the lever 21b is retained by a fastener, such as an Allen screw 23b. Thus, adjustment of the watchband 16b can be provided, but the watchband 16b cannot be adjusted while the user is wearing the tracking device 10b. Again the tracking device 10b is connected and disconnected similar to the connection system 18 of FIGS. 1A and 1B.

FIG. 4 illustrates another embodiment of the tracking device 10c. In this embodiment, a flexible metal band or braided cable 17c is connected directly to the watch body 12c, such as by welding, soldering, or other permanent connection. The cable 17c is hidden within the leather (or other material) band 16c such that the tracking device 10c appears to be an ordinary watch. The watchband 16c is connected and disconnected according to any of the connection systems of FIGS. 1-3.

FIG. 5 is a schematic illustrating a tracking and monitoring system in which the tracking device 10 can be used. The tracking device 10 can be any of the tracking devices 10, 10a, 10b, 10c of FIGS. 1-4 or any suitable variation. The tracking device 10 includes a GPS receiver 50 or other location determining circuitry (such as circuitry whose location is determined by cell towers). The tracking device 10 further includes communication circuitry 52, such as cell phone or other wireless data transmission circuitry. The tracking device 10 further includes a watch function 54, such that the tracking device 10 operates and appears as a normal watch. The tracking device 10 may optionally include a health monitoring circuit 56, such as for monitoring heart rate, blood pressure, temperature, blood sugar. This health related information can be used to either trigger a communication or can be periodically transmitted from the tracking device via communication circuitry 52, or can be retrieved via the communication circuitry 52.

The tracking device 10 further includes a panic or help button 32, with which the user can request assistance by initiating communication via the communication circuitry 52, which automatically transmits the location of the tracking device 10 as determined by the GPS 50, and optionally health related information to a cell tower 60 or other external communication circuitry (including wi-fl, or other data communication protocalls). The cell tower 60 is in communication with a central server 64. The central server 64 is equipped to monitor thousands of such tracking devices over a large area. The identification of the individual wearing the tracking device is stored in the server 63 and associated with that particular tracking device. Health information, contact information, historical information are all stored on server 64 and associated with that individual's tracking device 10. Satellites 58 also communicate with tracking device 10, including the GPS received 50 and optionally the communication circuitry

In use, if an individual is reported missing by their family, the server 64 can track the location of the individual's tracking device 10 and report that location to the family or to the authorities. The operators monitoring the server 64 can also track the health status of the individual wearing the tracking device 10 and report this to the family members or other authorities.

In some situations, if the individual wearing the tracking device 10 becomes lost or otherwise is in need of assistance, they either can press the help or panic button 32 which will initiate a call for help to the central server 64.

Although an example embodiment has been disclosed, a worker of ordinary skill in this art would recognize that certain modifications would come within the scope of the claims. For that reason, the following claims should be studied to determine their true scope and content.

1. A tracking device comprising:
a time-keeping device;
a watch display indicating time as indicated by the time-keeping device;
a location determining device for providing a location of the tracking device;
a watchband, the watchband including a rigid curved first bar and a rigid curved second bar pivotably connected to the first bar, the first bar and the second bar pivotable relative to one another between an open position and a closed position; and
a lock selectively locking the watchband to a user by locking the first bar and the second bar in the closed position.

2. The tracking device of claim 1 further including a communication circuit for reporting the location to a central server.

3. The tracking device of claim 1 further including a key way selectively unlocking the lock.

4. The tracking device of claim 3 wherein the key way selectively locks the lock.

5. The tracking device of claim 1 wherein the location determining device includes a GPS receiver.

6. The tracking device of claim 1 wherein the watch display includes a watch face and hands.

7. The tracking device of claim 1 further including a health monitoring circuit.

8. The tracking device of claim 7 further including a communication circuit for reporting a health condition as determined by the health monitoring circuit to a central server.

9. The tracking device of claim 1 wherein the watchband includes a first half and a second half, both secured to a watch body, the watch body housing the time keeping device and the location determining device.

10. The tracking device of claim 9 wherein the lock selectively connects the first half of the watchband to the second half.

11. A tracking device comprising:
a time-keeping device in a watch body;
a watch display indicating time as indicated by the time-keeping device, the watch display on the watch body;
a location determining device for providing a location of the tracking device, the location determining device in the watch body;
a watchband including a plurality of connected rigid links including a first link and a second link; and
a lock selectively locking the watchband to a user by selectively connecting the first link to the second link, the lock unlockable only by a key.

12. The tracking device of claim 11 wherein the location determining device includes a GPS receiver.

13. The tracking device of claim 12 wherein the watch display includes a watch face and hands.

14. The tracking device of claim 13 further including a health monitoring circuit.

15. The tracking device of claim 14 wherein the communication circuit reports a health condition as determined by the health monitoring circuit to the central server.

16. The tracking device of claim 12 further including a recessed button for activating a request for assistance.

17. A tracking device comprising:
a time-keeping device in a watch body;
a watch display indicating time as indicated by the time-keeping device, the watch display on the watch body;
a location determining device for providing a location of the tracking device, the location determining device in the watch body;
a watchband including a flexible metal cable hidden within an outer flexible material, the flexible metal cable connected directly to the watch body; and
a lock connected directly to the flexible metal cable selectively locking the watchband to a user, the lock unlockable only by a key.

18. The tracking device of claim 17 wherein the outer flexible material is leather.

19. The tracking device of claim 17 further including an adjustment mechanism for adjusting a length of the watchband.
